(19) United States
(12) Patent Application Publication
(10) Pub. No.: US 2025/0360520 A1
(43) Pub. Date: Nov. 27, 2025

(54) Hand shower and base showerhead with water flow switching mechanism

(71) Applicant: Sze Man Daphne CHAN, Kowloon (HK)

(72) Inventor: Sze Man Daphne CHAN, Kowloon (HK)

(21) Appl. No.: 18/670,744

(22) Filed: May 22, 2024

(51) Int. Cl. B05B 1/16; B05B 15/62; E03C 1/04

(52) U.S. Cl. CPC B05B 1/1609; B05B 15/62; E03C 1/0408

(57) ABSTRACT

A hand shower and base showerhead with water flow switching mechanism in which a movable flow switching magnet movable between a hand shower flow permitting position and a base showerhead flow permitting position is used to magnetically act on the magnetic hand shower flow control assembly and the magnetic base showerhead flow control assembly to achieve automatic switching of water flow from the hand shower to the base showerhead and vice versa.

### BACKGROUND OF THE INVENTION

The present invention relates to a shower equipment, and more specifically relates to a hand shower and base showerhead with water flow switching mechanism.

Hand shower and base showerhead combos are available in the marketplace to provide flexible showering experience to users. However, users usually need to manually activate a switch to switch the water flow from the hand shower to the base showerhead and vice versa. This causes inconvenience to users when users are taking shower.

### BRIEF SUMMARY OF THE INVENTION

In view of the aforesaid disadvantages now present in the prior art, the present invention provides a hand shower and base showerhead with water flow switching mechanism which allows automatic switching of water flow from the hand shower to the base showerhead and vice versa.

To attain the above object, the present invention provides a hand shower and base showerhead with water flow switching mechanism which comprises:
a hand shower having a hand shower head provided with a hand shower inlet and a hand shower outlet, and a hand shower handle which fluidly communicates with the hand shower inlet and a water source;
a magnetic hand shower flow control assembly movably disposed inside the hand shower head and is axially movable between a hand shower non-blocking position which allows water flow between the hand shower inlet and the hand shower outlet and a hand shower blocking position which blocks water flow between the hand shower inlet and the hand shower outlet; the hand shower flow control assembly is biased towards the hand shower blocking position;
a base showerhead having a base showerhead inlet which fluidly communicates with the water source, a base showerhead outlet and a receiving recess for removably receiving the hand shower head;
a magnetic base showerhead flow control assembly movably disposed inside the base showerhead and axially aligned with the hand shower flow control assembly when the hand shower head is received in the receiving recessing; the base showerhead flow control assembly is axially movable between a base showerhead non-blocking position which allows water flow between the base showerhead inlet and the base showerhead outlet and a base showerhead blocking position which blocks water flow between the base showerhead inlet and the base showerhead outlet; the base showerhead flow control assembly is biased towards the base showerhead blocking position;
a movable flow switching magnet disposed inside the hand shower head and axially aligned with the hand shower flow control assembly; the movable flow switching magnet is axially movable between a hand shower flow permitting position and a base showerhead flow permitting position, and is biased towards the hand shower flow permitting position;
the movable flow switching magnet is configured to have a magnetic force strong enough to attract the hand shower flow control assembly for the hand shower flow control assembly to overcome its biasing force to move to the hand shower non-blocking position when the hand shower is removed from the receiving recess of the base showerhead and the movable flow switching magnet is biased to the hand shower flow permitting position;
the base showerhead flow control assembly is configured to have a magnetic force strong enough for the base showerhead flow control assembly and the movable flow switching magnet to overcome their respective biasing forces to move towards each other and thereby moving the movable flow switching magnet to the base showerhead flow permitting position and the base showerhead flow control assembly to the base showerhead non-blocking position when the hand shower head is received in the receiving recess of the base showerhead and the hand shower flow control assembly is biased to the hand shower blocking position as the magnetic force of the movable flow switching magnet is not strong enough to attract the hand shower flow control assembly to overcome its biasing force when it is moved to the base showerhead flow permitting position.

Preferably, the hand shower flow control assembly comprises a hand shower flow control magnet and a hand shower flow control member which is fixedly connected to a first end of the hand shower flow control magnet distant from the movable flow switching magnet.

Preferably, the hand shower flow control assembly further comprises a first housing and a first spring; the first housing has a first recess for receiving the hand shower flow control magnet; the first spring has a first end which is fixedly coupled to an inner end of the first recess and a second end which is fixedly coupled to a second end of the hand shower flow control magnet to bias the hand shower flow control magnet against the inner end of the first recess.

Preferably, the first housing is coupled with a second housing to form a hand shower water guiding chamber having a hand shower water guiding chamber inlet which fluidly communicates with the hand shower inlet and a hand shower water guiding chamber outlet which fluidly communicates with the hand shower outlet; the hand shower water guiding chamber outlet is sealed by the hand shower flow control member when the hand shower flow control assembly is at the hand shower blocking position; a first gap is formed between the hand shower water guiding chamber outlet and the hand shower flow control member for water to leave the hand shower water guiding chamber when the hand shower flow control assembly is at the hand shower non-blocking position.

Preferably, the base showerhead flow control assembly comprises a base showerhead flow control magnet and a base showerhead flow control member which is fixedly connected to a first end of the base showerhead flow control magnet distant from the receiving recess.

Preferably, the receiving recess has an inner end which is coupled with a third housing to form a base showerhead water guiding chamber having a base showerhead water guiding chamber inlet which fluidly communicates with the base showerhead inlet and a base showerhead water guiding chamber outlet which fluidly communicates with the base showerhead outlet; the base showerhead water guiding chamber outlet is sealed by the base showerhead flow control member when the base showerhead flow control assembly is at the base showerhead blocking position; a second gap is formed between the base showerhead water guiding chamber outlet and the base showerhead flow control member for water to leave the base showerhead water guiding chamber when the base showerhead flow control assembly is at the base showerhead non-blocking position; a second recess is provided at the inner end of the recessing recess for receiving the base showerhead flow control magnet; a second spring has a first end which is fixedly coupled to an inner end of the second recess and a second end which is fixedly coupled to a second end of the base showerhead flow control magnet to bias the base showerhead flow control magnet against the inner end of the second recess.

Preferably, a mode switch is rotatably connected at a first end of the hand shower which is close to an inner end of the receiving recess of the base showerhead when the hand shower head is received in the receiving recess of the base showerhead; the mode switch is provided with a third recess for receiving the movable flow switching magnet and a fourth recess for fixedly receiving a first fixed magnet; the mode switch is rotatable between a first position where the third recess and the movable flow switching magnet are axially aligned with the hand shower flow control assembly and the base showerhead flow control assembly and a second position where the fourth recess and the first fixed magnet is axially aligned with the hand shower flow control assembly and the base showerhead flow control assembly; the first fixed magnet is configured to have a magnetic force strong enough to attract the hand shower flow control magnet for the hand shower flow control assembly to overcome its biasing force to move to the hand shower non-blocking position at the second position; the first fixed magnet is configured to have no magnetic impact on the base showerhead flow control assembly at both the first position and the second position.

Preferably, the third recess and the fourth recess are circumferentially spaced apart from each other by 180 degrees.

Preferably, the base showerhead further comprises a second fixed magnet at the inner end of the receiving recess at a position which axially aligns with the first fixed magnet of the mode switch when the mode switch is at the first position and axially aligns with the movable flow switching magnet when the mode switch is at the second position for securing the hand shower head in the receiving recess by magnetic attraction.

Preferably, a third spring having a first end fixedly coupled to an inner end of the third recess and a second end fixedly coupled to the movable flow switching magnet biases the movable flow switching magnet against the inner end of the third recess.

### BRIEF DESCRIPTION OF THE DRAWINGS

FIG. 1 is a first perspective exploding view showing the structure of a preferred embodiment of the present invention.

FIG. 2 is a second perspective exploding view showing the structure of a preferred embodiment of the present invention.

FIG. 3 is a perspective view showing the hand shower removed from the base showerhead.

FIG. 4 is an enlarged partial sectional view of the base showerhead when the mode switch is at the first position and the hand shower head is removed from the receiving recess of the base showerhead.

FIG. 5 is an enlarged partial sectional view of the hand shower when the mode switch is at the first position and the hand shower head is removed from the receiving recess of the base showerhead.

FIG. 6 is a perspective view showing the hand shower received in the receiving recess of the base showerhead.

FIG. 7 is an enlarged partial sectional view of the hand shower and the base showerhead when the mode switch is at the first position and the hand shower head is received in the receiving recess of the base showerhead.

FIG. 8 is an enlarged partial sectional view of the base showerhead when the mode switch is at the second position and the hand shower head is removed from the receiving recess of the base showerhead.

FIG. 9 is an enlarged partial sectional view of the hand shower when the mode switch is at the second position and the hand shower head is removed from the receiving recess of the base showerhead.

FIG. 10 is an enlarged partial sectional view of the hand shower and the base showerhead when the mode switch is at the second position and the hand shower head is received in the receiving recess of the base showerhead.

### DETAILED DESCRIPTION OF THE INVENTION

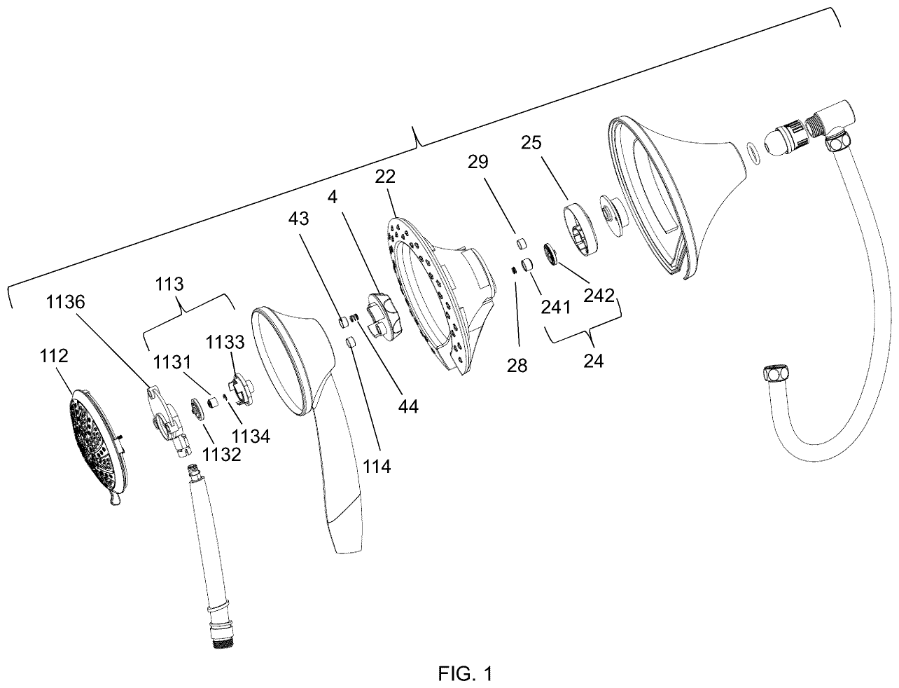

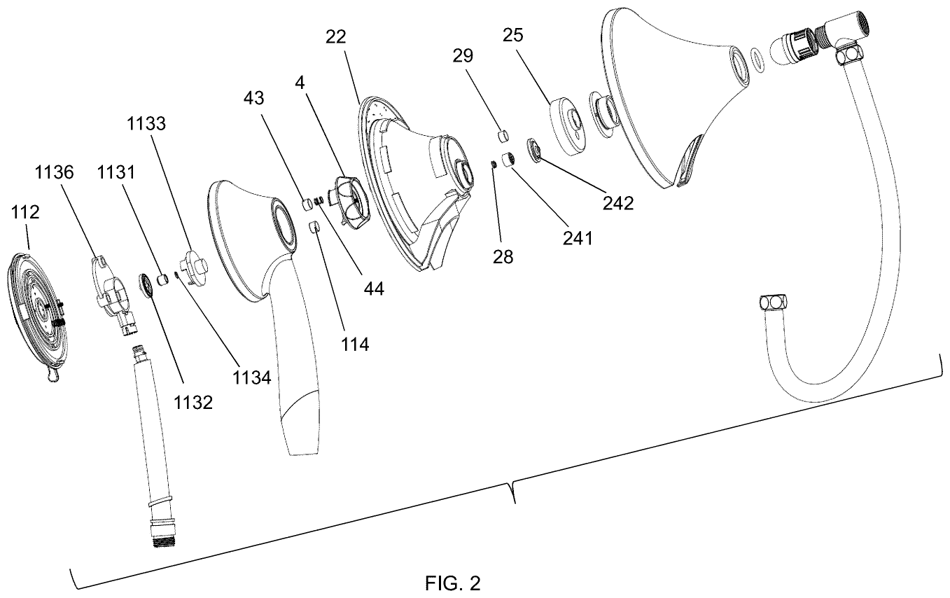

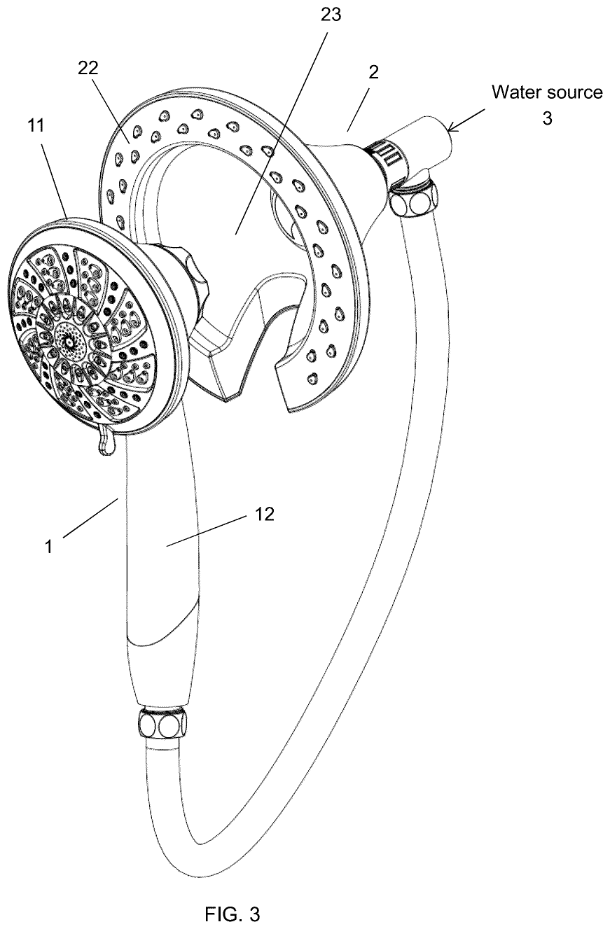

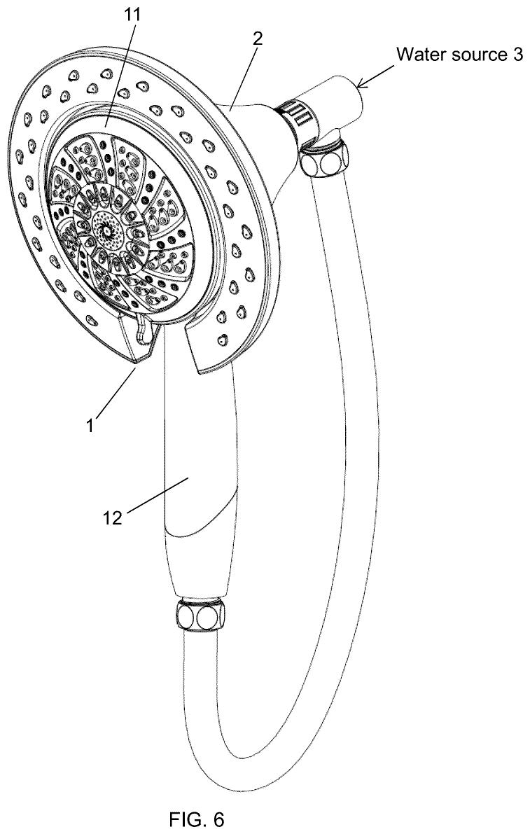

The present invention is described further in detail below with reference to an embodiment and FIGS. 1-10.

As shown in FIGS. 1-10, the present embodiment comprises a hand shower 1 and a base showerhead 2. The hand shower 1 has a hand shower head 11 and a hand shower handle 12. The hand shower head 11 is provided with a hand shower inlet 111 and a hand shower outlet 112. The hand shower handle 12 fluidly communicates with the hand shower inlet 111 and a water source 3. A magnetic hand shower flow control assembly 113 is movably disposed inside the hand shower head 11 and is axially movable between a hand shower non-blocking position which allows water flow between the hand shower inlet 111 and the hand shower outlet 112 and a hand shower blocking position which blocks water flow between the hand shower inlet 111 and the hand shower outlet 112. The hand shower flow control assembly 113 is biased towards the hand shower blocking position.

The hand shower flow control assembly 113 comprises a hand shower flow control magnet 1131 and a hand shower flow control member 1132 which is fixedly connected to a first end 1131a of the hand shower flow control magnet 1131 distant from a movable flow switching magnet 114. The hand shower flow control assembly 113 further comprises a first housing 1133 and a first spring 1134. The first housing 1133 has a first recess 1135 for receiving the hand shower flow control magnet 1131. The first spring 1134 has a first end 1134a which is fixedly coupled to an inner end 1135a of the first recess 1135 and a second end 1134b which is fixedly coupled to a second end 1131b of the hand shower flow control magnet 1131 to bias the hand shower flow control magnet 1131 against the inner end 1135a of the first recess 1135. The first housing 1133 is coupled with a second housing 1136 to form a hand shower water guiding chamber 1137 having a hand shower water guiding chamber inlet 1137a which fluidly communicates with the hand shower inlet 111 and a hand shower water guiding chamber outlet 1137b which fluidly communicates with the hand shower outlet 112. The hand shower water guiding chamber 1137 is sealed by the hand shower flow control member 1132 when the hand shower flow control assembly 113 is at the hand shower blocking position; a first gap 1138 is formed between the hand shower water guiding chamber outlet 1137b and the hand shower flow control member 1132 for water to leave the hand shower water guiding chamber 1137 when the hand shower flow control assembly 113 is at the hand shower non-blocking position.

The base showerhead 2 has a base showerhead inlet 21 which fluidly communicates with the water source 3, a base showerhead outlet 22 and a receiving recess 23 for removably receiving the hand shower head 11. A magnetic base showerhead flow control assembly 24 is movably disposed inside the base showerhead 2 and axially aligned with the hand shower flow control assembly 113 when the hand shower head 11 is received in the receiving recess 23. The base showerhead flow control assembly 24 is axially movable between a base showerhead non-blocking position which allows water flow between the base showerhead inlet 21 and the base showerhead outlet 22 and a base showerhead blocking position which blocks water flow between the base showerhead inlet 21 and the base showerhead outlet 22. The base showerhead flow control assembly 24 is biased towards the base showerhead blocking position.

The base showerhead flow control assembly 24 comprises a base showerhead flow control magnet 241 and a base showerhead flow control member 242 which is fixedly connected to a first end 241a of the base showerhead flow control magnet 241 distant from the receiving recess 23. The receiving recess 23 has an inner end 231 which is coupled with a third housing 25 to form a base showerhead water guiding chamber 26 having a base showerhead water guiding chamber inlet 261 which fluidly communicates with the base showerhead inlet 21 and a base showerhead water guiding chamber outlet 262 which fluidly communicates with the base showerhead outlet 22. The base showerhead water guiding chamber outlet 262 is sealed by the base showerhead flow control member 242 when the base showerhead flow control assembly 24 is at the base showerhead blocking position; a second gap 263 is formed between the base showerhead water guiding chamber outlet 262 and the base showerhead flow control member 242 for water to leave the base showerhead water guiding chamber 26 when the base showerhead flow control assembly 24 is at the base showerhead non-blocking position. A second recess 27 is provided at the inner end 231 of the recessing recess 23 for receiving the base showerhead flow control magnet 241. A second spring 28 has a first end 281 which is fixedly coupled to an inner end 271 of the second recess 27 and a second end 282 which is fixedly coupled to a second end 241b of the base showerhead flow control magnet 241 to bias the base showerhead flow control magnet 241 against the inner end 271 of the second recess 27.

The movable flow switching magnet 114 is disposed inside the hand shower head 11 and axially aligned with the hand shower flow control assembly 113. The movable flow switching magnet 114 is axially movable between a hand shower flow permitting position and a base showerhead flow permitting position, and is biased towards the hand shower flow permitting position.

The movable flow switching magnet 114 is configured to have a magnetic force strong enough to attract the hand shower flow control assembly 113 for the hand shower flow control assembly 113 to overcome its biasing force to move to the hand shower non-blocking position when the hand shower 1 is removed from the receiving recess 23 of the base showerhead 2 and the movable flow switching magnet 114 is biased to the hand shower flow permitting position.

The base showerhead flow control assembly 24 is configured to have a magnetic force strong enough for the base showerhead flow control assembly 24 and the movable flow switching magnet 114 to overcome their respective biasing forces to move towards each other and thereby moving the movable flow switching magnet 114 to the base showerhead flow permitting position and the base showerhead flow control assembly 24 to the base showerhead non-blocking position when the hand shower head 11 is received in the receiving recess 23 of the base showerhead 2 and the hand shower flow control assembly 113 is biased to the hand shower blocking position as the magnetic force of the movable flow switching magnet 114 is not strong enough to attract the hand shower flow control assembly 113 to overcome its biasing force when it is moved to the base showerhead flow permitting position.

In this embodiment, a mode switch 4 is rotatably connected at a first end 11a of the hand shower 11 which is close to the inner end 231 of the receiving recess 23 of the base showerhead 2 when the hand shower head 11 is received in the receiving recess 23 of the base showerhead 2. The mode switch 4 is provided with a third recess 41 for receiving the movable flow switching magnet 114 and a fourth recess 42 for fixedly receiving a first fixed magnet 43. The mode switch 4 is rotatable between a first position where the third recess 41 and the movable flow switching magnet 114 are axially aligned with the hand shower flow control assembly 113 and the base showerhead flow control assembly 24 and a second position where the fourth recess 42 and the first fixed magnet 43 is axially aligned with the hand shower flow control assembly 113 and the base showerhead flow control assembly 24. The first fixed magnet 43 is configured to have a magnetic force strong enough to attract the hand shower flow control magnet 1131 for the hand shower flow control assembly 113 to overcome its biasing force to move to the hand shower non-blocking position at the second position. The first fixed magnet 43 is configured to have no magnetic impact on the base showerhead flow control assembly 24 at both the first position and the second position. The third recess 41 and the fourth recess 42 are circumferentially spaced apart from each other by 180 degrees. A third spring 44 has a first end 441 which is fixedly coupled to an inner end 411 of the third recess 41 and a second end 442 which is fixedly coupled to the movable flow switching magnet 114 to bias the movable flow switching magnet 114 against the inner end 411 of the third recess 41.

In this embodiment, the base showerhead 2 further comprises a second fixed magnet 29 at the inner end 231 of the receiving recess 23 at a position which axially aligns with the first fixed magnet 43 of the mode switch 4 when the mode switch 4 is at the first position and axially aligns with the movable flow switching magnet 114 when the mode switch 4 is at the second position for securing the hand shower head 11 in the receiving recess 23 by magnetic attraction.

The operation of the present embodiment is as follows:

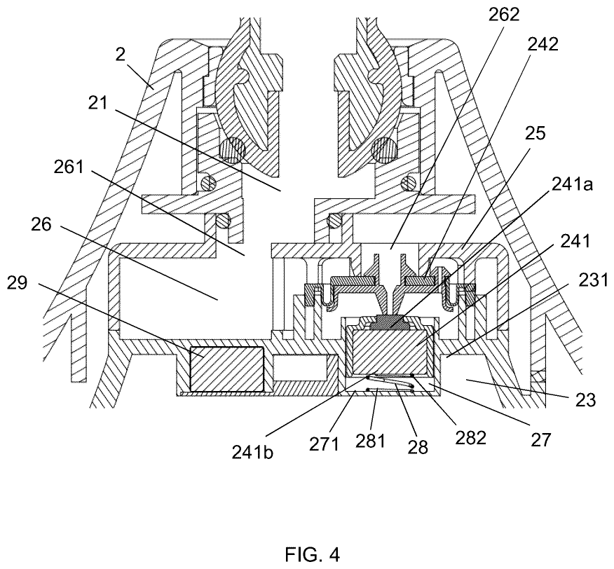

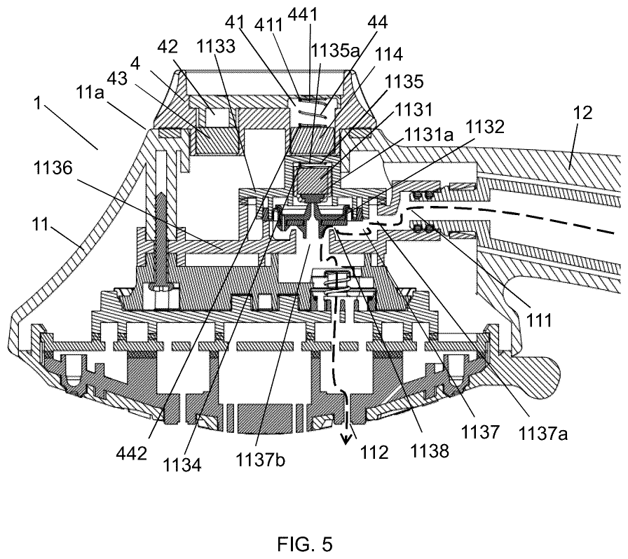

As illustrated in FIGS. 4 and 5, when the mode switch 4 is at the first position and the hand shower head 11 is removed from the receiving recess 23 of the base showerhead 2, the third recess 41 and the movable flow switching magnet 114 are axially aligned with the hand shower flow control assembly 113 and the base showerhead flow control assembly 24. The base showerhead flow control magnet 241 is biased by the second spring 28 against the inner end 271 of the second recess 27 so that the base showerhead flow control assembly 24 is at the base showerhead blocking position. As a result, as water flow from the water source 3 passes through the base showerhead inlet 21 and enters the base showerhead water guiding chamber 26 via the base showerhead water guiding chamber inlet 261, water flow is blocked by the base showerhead flow control member 242 and cannot leave the base showerhead water guiding chamber 26 via the base showerhead water guiding chamber outlet 262 to flow to the base showerhead outlet 22. The movable flow switching magnet 114 is biased by the third spring 44 against the inner end 441 of the third recess 44 so that the movable flow switching magnet 114 is at the hand shower flow permitting position. At this time, the magnetic force of the movable flow switching magnet 114 is strong enough to attract the hand shower flow control magnet 1131 to overcome the biasing force of the first spring 1134 so that the hand shower flow control assembly 113 is moved to the hand shower non-blocking position. As a result, after water flow from the water source 3 passes through the hand shower handle 12 and enters the hand shower head 11 via the hand shower inlet 111, water flow enters the hand shower water guiding chamber 1137 via the hand shower water guiding chamber inlet 1137a. As the hand shower flow control assembly 113 is at the hand shower non-blocking position, a first gap 1138 is formed between the hand shower water guiding chamber outlet 1137b and the hand shower flow control member 1132 for water to leave the hand shower water guiding chamber 1137 and flows to the hand shower outlet 112.

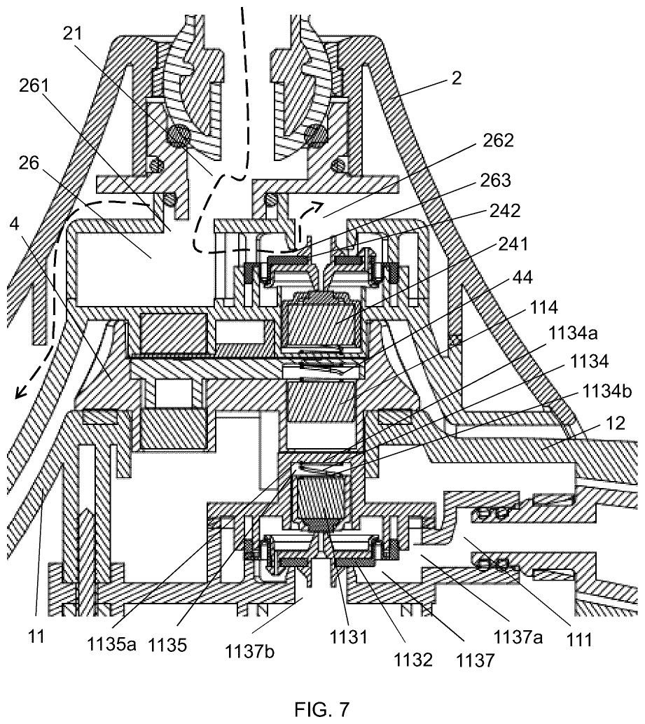

As illustrated in FIG. 7, when the mode switch 4 is at the first positon and the hand shower head 11 is received in the receiving recess 23 of the base showerhead 2, the magnetic force of the base showerhead flow control magnet 241 is strong enough to attract the movably flow switching magnet 114 to overcome the biasing force of the third spring 44 so that the movable flow switching magnet 114 is moved to the base showerhead flow permitting position and the base showerhead flow control assembly 24 is moved to the base showerhead non-blocking position. As a result, water flow from the water source 3 passes through the base showerhead inlet 21 and enters the base showerhead water guiding chamber 26 via the base showerhead water guiding chamber inlet 261. As the base showerhead flow control assembly 24 is at the base showerhead non-blocking position, a second gap 263 is formed between the base showerhead water guiding chamber outlet 262 and the base showerhead flow control member 242 for water to leave the base showerhead water guiding chamber 26 and flows to the base showerhead outlet 22. At this time, as the magnetic force of the movable flow switching magnet 114 is not strong enough to attract the hand shower flow control magnet 1131 to overcome the biasing force of the first spring 1134, the hand shower flow control magnet 1131 is biased by the first spring 1134 against the inner end 1135a of the first recess 1135 and move the hand shower flow control assembly 113 to the hand shower blocking position. As a result, after water flow from the water source 3 passes through the hand shower handle 12 and enters the hand shower head 11 via the hand shower inlet 111, water flow enters the hand shower water guiding chamber 1137 via the hand shower water guiding chamber inlet 1137a. As the hand shower flow control assembly 113 is at the hand shower blocking position, water flow is blocked by the hand shower flow control member 1132 and cannot leave the hand shower water guiding chamber 1137 via the hand shower water guiding chamber outlet 1137b to flow to the hand shower outlet 112.

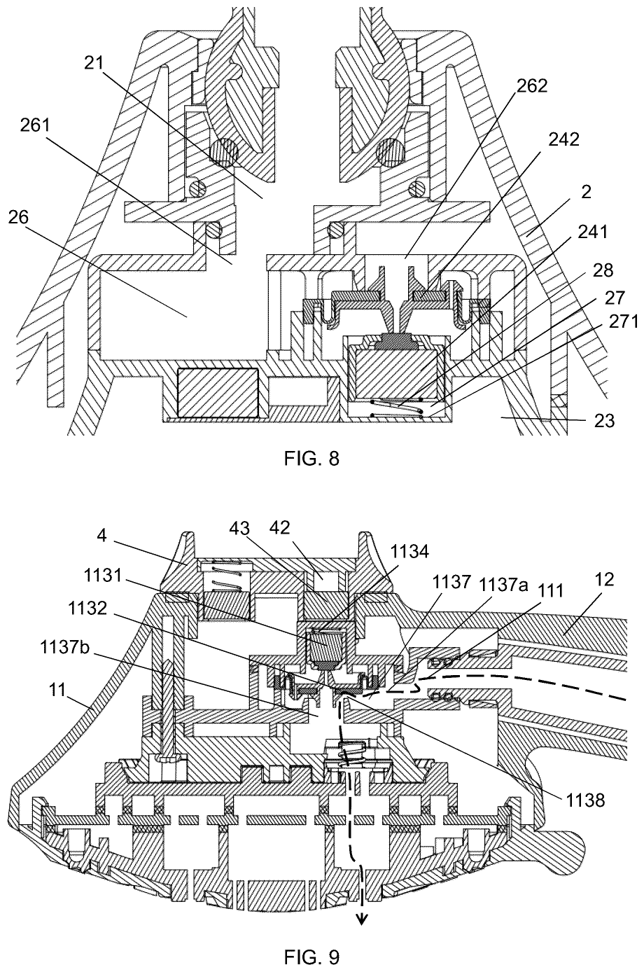

As illustrated in FIGS. 8 and 9, when the mode switch 4 is at the second position and the hand shower head 11 is removed from the receiving recess 23 of the base showerhead 2, the fourth recess 42 and the first fixed magnet 43 is axially aligned with the hand shower flow control assembly 113 and the base showerhead flow control assembly 24. The magnetic force of the first fixed magnet 43 is strong enough to attract the hand shower flow control magnet 1131 to overcome the biasing force of the first spring 1134 for the hand shower flow control assembly 113 to move to the hand shower non-blocking position. As a result, after water flow from the water source 3 passes through the hand shower handle 12 and enters the hand shower head 11 via the hand shower inlet 111, water flow enters the hand shower water guiding chamber 1137 via the hand shower water guiding chamber inlet 1137a. As the hand shower flow control assembly 113 is at the hand shower non-blocking position, a first gap 1138 is formed between the hand shower water guiding chamber outlet 1137b and the hand shower flow control member 1132 for water to leave the hand shower water guiding chamber 1137 and flows to the hand shower outlet 112. As the first fixed magnet 43 has no magnetic impact on the base showerhead flow control assembly 24, the base showerhead flow control magnet 241 is biased by the second spring 28 against the inner end 271 of the second recess 27 so that the base showerhead flow control assembly 24 is at the base showerhead blocking position. As a result, as water flow from the water source 3 passes through the base showerhead inlet 21 and enters the base showerhead water guiding chamber 26 via the base showerhead water guiding chamber inlet 261, water flow is blocked by the base showerhead flow control member 242 and cannot leave the base showerhead water guiding chamber 26 via the base showerhead water guiding chamber outlet 262 to flow to the base showerhead outlet 22.

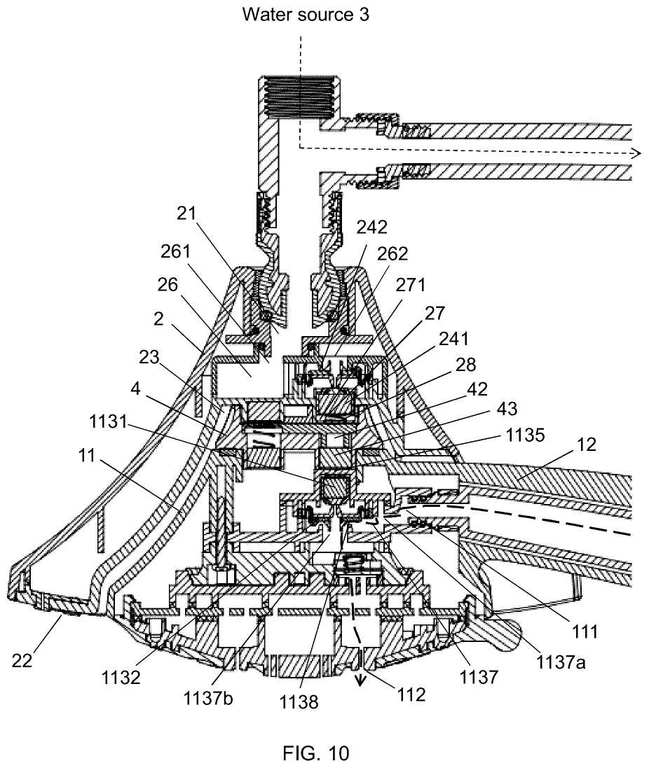

As illustrated in FIG. 10, when the mode switch 4 is at the second position and the hand shower head 11 is received in the receiving recess 23 of the base showerhead 2, the fourth recess 42 and the first fixed magnet 43 is axially aligned with the hand shower flow control assembly 113 and the base showerhead flow control assembly 24. The magnetic force of the first fixed magnet 43 is strong enough to attract the hand shower flow control magnet 1131 to overcome the biasing force of the first spring 1134 for the hand shower flow control assembly 113 to move to the hand shower non-blocking position. As a result, after water flow from the water source 3 passes through the hand shower handle 12 and enters the hand shower head 11 via the hand shower inlet 111, water flow enters the hand shower water guiding chamber 1137 via the hand shower water guiding chamber inlet 1137a. As the hand shower flow control assembly 113 is at the hand shower non-blocking position, a first gap 1138 is formed between the hand shower water guiding chamber outlet 1137b and the hand shower flow control member 1132 for water to leave the hand shower water guiding chamber 1137 and flows to the hand shower outlet 112. As the first fixed magnet 43 has no magnetic impact on the base showerhead flow control assembly 24, the base showerhead flow control magnet 241 is biased by the second spring 28 against the inner end 271 of the second recess 27 so that the base showerhead flow control assembly 24 is at the base showerhead blocking position. As a result, as water flow from the water source 3 passes through the base showerhead inlet 21 and enters the base showerhead water guiding chamber 26 via the base showerhead water guiding chamber inlet 261, water flow is blocked by the base showerhead flow control member 242 and cannot leave the base showerhead water guiding chamber 26 via the base showerhead water guiding chamber outlet 262 to flow to the base showerhead outlet 22.

The above description is only a preferred embodiment of the present invention. The present invention should not be considered limited to the above description. A person skilled in this field of art may make changes to the specific implementation of the present invention and to the scope of application of the present invention based on the inventive idea of the present invention.

What is claimed is:

1. Hand shower and base showerhead with water flow switching mechanism which comprises
a hand shower having a hand shower head provided with a hand shower inlet and a hand shower outlet, and a hand shower handle which fluidly communicates with the hand shower inlet and a water source;
a magnetic hand shower flow control assembly movably disposed inside the hand shower head and is axially movable between a hand shower non-blocking position which allows water flow between the hand shower inlet and the hand shower outlet and a hand shower blocking position which blocks water flow between the hand shower inlet and the hand shower outlet; the hand shower flow control assembly is biased towards the hand shower blocking position;
a base showerhead having a base showerhead inlet which fluidly communicates with the water source, a base showerhead outlet and a receiving recess for removably receiving the hand shower head;
a magnetic base showerhead flow control assembly movably disposed inside the base showerhead and axially aligned with the hand shower flow control assembly when the hand shower head is received in the receiving recessing; the base showerhead flow control assembly is axially movable between a base showerhead non-blocking position which allows water flow between the base showerhead inlet and the base showerhead outlet and a base showerhead blocking position which blocks water flow between the base showerhead inlet and the base showerhead outlet; the base showerhead flow control assembly is biased towards the base showerhead blocking position;
a movable flow switching magnet disposed inside the hand shower head and axially aligned with the hand shower flow control assembly; the movable flow switching magnet is axially movable between a hand shower flow permitting position and a base showerhead flow permitting position, and is biased towards the hand shower flow permitting position;
the movable flow switching magnet is configured to have a magnetic force strong enough to attract the hand shower flow control assembly for the hand shower flow control assembly to overcome its biasing force to move to the hand shower non-blocking position when the hand shower is removed from the receiving recess of the base showerhead and the movable flow switching magnet is biased to the hand shower flow permitting position;
the base showerhead flow control assembly is configured to have a magnetic force strong enough for the base showerhead flow control assembly and the movable flow switching magnet to overcome their respective biasing forces to move towards each other and thereby moving the movable flow switching magnet to the base showerhead flow permitting position and the base showerhead flow control assembly to the base showerhead non-blocking position when the hand shower head is received in the receiving recess of the base showerhead and the hand shower flow control assembly is biased to the hand shower blocking position as the magnetic force of the movable flow switching magnet is not strong enough to attract the hand shower flow control assembly to overcome its biasing force when it is moved to the base showerhead flow permitting position.

2. The hand shower and base showerhead with water flow switching mechanism as in claim 1, wherein the hand shower flow control assembly comprises a hand shower flow control magnet and a hand shower flow control member which is fixedly connected to a first end of the hand shower flow control magnet distant from the movable flow switching magnet.

3. The hand shower and base showerhead with water flow switching mechanism as in claim 2, wherein the hand shower flow control assembly further comprises a first housing and a first spring; the first housing has a first recess for receiving the hand shower flow control magnet; the first spring has a first end which is fixedly coupled to an inner end of the first recess and a second end which is fixedly coupled to a second end of the hand shower flow control magnet to bias the hand shower flow control magnet against the inner end of the first recess.

4. The hand shower and base showerhead with water flow switching mechanism as in claim 3, wherein the first housing is coupled with a second housing to form a hand shower water guiding chamber having a hand shower water guiding chamber inlet which fluidly communicates with the hand shower inlet and a hand shower water guiding chamber outlet which fluidly communicates with the hand shower outlet; the hand shower water guiding chamber outlet is sealed by the hand shower flow control member when the hand shower flow control assembly is at the hand shower blocking position; a first gap is formed between the hand shower water guiding chamber outlet and the hand shower flow control member for water to leave the hand shower water guiding chamber when the hand shower flow control assembly is at the hand shower non-blocking position.

5. The hand shower and base showerhead with water flow switching mechanism as in claim 1, wherein the base showerhead flow control assembly comprises a base showerhead flow control magnet and a base showerhead flow control member which is fixedly connected to a first end of the base showerhead flow control magnet distant from the receiving recess.

6. The hand shower and base showerhead with water flow switching mechanism as in claim 5, wherein the receiving recess has an inner end which is coupled with a third housing to form a base showerhead water guiding chamber having a base showerhead water guiding chamber inlet which fluidly communicates with the base showerhead inlet and a base showerhead water guiding chamber outlet which fluidly communicates with the base showerhead outlet; the base showerhead water guiding chamber outlet is sealed by the base showerhead flow control member when the base showerhead flow control assembly is at the base showerhead blocking position; a second gap is formed between the base showerhead water guiding chamber outlet and the base showerhead flow control member for water to leave the base showerhead water guiding chamber when the base showerhead flow control assembly is at the base showerhead non-blocking position; a second recess is provided at the inner end of the recessing recess for receiving the base showerhead flow control magnet; a second spring has a first end which is fixedly coupled to an inner end of the second recess and a second end which is fixedly coupled to a second end of the base showerhead flow control magnet to bias the base showerhead flow control magnet against the inner end of the second recess.

7. The hand shower and base showerhead with water flow switching mechanism as in claim 1, wherein a mode switch is rotatably connected at a first end of the hand shower which is close to an inner end of the receiving recess of the base showerhead when the hand shower head is received in the receiving recess of the base showerhead; the mode switch is provided with a third recess for receiving the movable flow switching magnet and a fourth recess for fixedly receiving a first fixed magnet; the mode switch is rotatable between a first position where the third recess and the movable flow switching magnet are axially aligned with the hand shower flow control assembly and the base showerhead flow control assembly and a second position where the fourth recess and the first fixed magnet is axially aligned with the hand shower flow control assembly and the base showerhead flow control assembly; the first fixed magnet is configured to have a magnetic force strong enough to attract the hand shower flow control magnet for the hand shower flow control assembly to overcome its biasing force to move to the hand shower non-blocking position at the second position; the first fixed magnet is configured to have no magnetic impact on the base showerhead flow control assembly at both the first position and the second position.

8. The hand shower and base showerhead with water flow switching mechanism as in claim 7, wherein the third recess and the fourth recess are circumferentially spaced apart from each other by 180 degrees.

9. The hand shower and base showerhead with water flow switching mechanism as in claim 7, wherein the base showerhead further comprises a second fixed magnet at the inner end of the receiving recess at a position which axially aligns with the first fixed magnet of the mode switch when the mode switch is at the first position and axially aligns with the movable flow switching magnet when the mode switch is at the second position for securing the hand shower head in the receiving recess by magnetic attraction.

10. The hand shower and base showerhead with water flow switching mechanism as in claim 7, wherein a third spring having a first end fixedly coupled to an inner end of the third recess and a second end fixedly coupled to the movable flow switching magnet biases the movable flow switching magnet against the inner end of the third recess.
